(19) United States
(12) Patent Application Publication
(10) Pub. No.: US 2003/0002636 A1
(43) Pub. Date: Jan. 2, 2003

(54) DSL splitter

(76) Inventor: Gene Alan Nelson, Carrollton, TX (US)

Correspondence Address: JERRY D. LENTZ, Fish & Richardson P.C., 225 Franklin Street, Boston, MA, 02110-2804, US

(21) Appl. No.: 09/894,408

(22) Filed: Jun. 28, 2001

(51) Int. Cl. H04M 11/00

(52) U.S. Cl. 379/90.01

(57) ABSTRACT

An apparatus for receiving and transmitting a combined DSL signal on a first set of wires and transmitting a primary filtered signal on a second set of wires includes an input port for receiving the combined signal, a primary filter for filtering the combined signal and an output port for transmitting the primary filtered signal to the second set of wires.

### TECHNICAL FIELD

This invention relates to digital subscriber lines.

### BACKGROUND

Digital Subscriber Line (DSL) service combines low frequency (LF) voice signals and high frequency (HF) data signals on a single phone line. A customer who subscribes to DSL service receives a combined DSL signal at their premises that must be divided into the LF bandwidth (approximately 0-3 kHZ) for use by POTS devices (“Plain Old Telephone Service”: e.g., telephones, answering machines and faxes) and into the HF bandwidth (approximately 25 KHz-1 MHZ) for use by data devices (e.g., modems, personal computers). Typically an external bandwidth splitter is installed at the customer's premises to divide the combined signal before it enters the residence or business. The cost to install an external bandwidth splitter can be quite high. Furthermore, the external splitter may not be an option in some residential situations, such as rental units, where rental restrictions or space limitations do not allow for the external installation.

Some DSL modems allow a “splitterless” connection to a DSL line, that is, they do not require an external bandwidth splitter. A typical splitterless modem configuration inputs the combined DSL signal from a phone line to a high-pass filter contained in the modem to produce the HF data signal output. Each POTS device is connected to the combined DSL signal through a separate low-pass filter (to block the high frequency data signals). In the splitterless modem configuration, the quality of the voice signals received and transmitted to and from the POTS devices can be negatively affected by the HF data signals. The negative effects include an increase in background noise, echoes in transmitted and received speech, and interference with “custom calling” features, such as caller-id and call-waiting.

### SUMMARY

According to an aspect of this invention an apparatus includes an input/output port for receiving and transmitting a combined signal on a first set of wires and transmitting a primary filtered signal on a second set of wires, and a first filter having an input port for receiving the combined signal from the first set of wires, a primary filter for receiving the combined signal and outputting a primary filtered signal, and an output port for transmitting the primary filtered signal on the second set of wires.

One or more of the following features may also be included. The first set of wires and the second set of wires may be phone wires, the combined signal may be a DSL signal, the primary filter may be a low-pass filter, the low-pass filter may be an active or passive filter, the apparatus may further include a second filter having an input/output port for receiving and transmitting the primary filtered signal on the second set of wires, a secondary filter for receiving the primary filtered signal and outputting a secondary filtered signal, and an output port for transmitting the secondary filtered signal on a third set of wires to a POTS device, the second filter may be a low-pass filter, the low-pass filter may be an active or passive filter, the apparatus may further include a switch circuit coupled to the input/output port and the input port of the first filter, the switch circuit configured to control the selective coupling of the first set of wires or the second set of wires to the input port of the first filter.

According to a further aspect of this invention a phone line testing apparatus includes an input port for receiving a signal from wires 1-and-4 of a RJ11 phone jack, a primary filter for receiving the signal from the wires 1-and-4 wires and outputting a filtered signal, and an output port for transmitting the filtered signal on wires 2-and-3 of a RJ 11 phone jack to a receiving device.

One or more of the following features may also be included: the receiving device may be a POTS device.

According to a further aspect of this invention a method for testing a phone line includes inputting a signal from wires 1-and-4 of a RJ11 phone jack, filtering the signal, outputting a filtered signal on wires 2-and-3 of a RJ11 phone jack, receiving the filtered signal at a receiving device, and listening to the received filtered signal at the receiving device.

One or more of the following features may also be included: the receiving device may be a POTS device.

According to a further aspect of this invention a method for receiving and transmitting a combined signal over phone wires includes receiving a combined signal on a first set of phone wires, filtering the combined signal, and outputting a primary filtered signal on a second set of phone wires.

One or more of the following features may also be included: receiving a DSL signal, filtering with a low-pass filter, receiving a DSL signal, filtering with an active filter, filtering with a passive filter, the method may further include receiving the primary filtered signal on the second set of phone wires, filtering the primary filtered signal, and outputting a secondary filtered signal on a third set of phone wires to a POTS device, the method may include receiving a DSL signal, filtering with a low-pass filter, receiving a DSL signal, filtering with an active filter, filtering with a passive filter, and the method may include switching between the first set of phone wires and the second set of phone wires to select which set of wires are connected to an input port of a first filter.

Embodiments of the invention may have one more of the following advantages. The splitter apparatus improves the quality of voice signals transmitted and received over a combined DSL phone line. The apparatus utilizes existing premises wiring without requiring the inconvenience or expense of re-wiring. The primary filtered LF output is transmitted over the existing wiring so that any POTS device can connect to the premises wiring circuit using a secondary filter device. The filters provided may be active or passive. The double-filtered LF output to a POTS device improves voice quality and also improves the operation of custom calling phone features (e.g., call-waiting and caller-id). In one embodiment the apparatus also provides a switch so a user can choose between primary and secondary phone lines, that is, providing a user with the ability to have two phone lines active and choosing which line to input to the DSL modem. The secondary filter device also provides a simple test capability for the secondary phone line, therefore avoiding an expensive service call to the phone service provider.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatic view of an embodiment of the invention;

FIG. 2 is a diagrammatic view of another embodiment of the invention; and

FIG. 3 is a diagrammatic view of another embodiment of the invention.

Like reference symbols in the various drawings indicate like elements.

### DETAILED DESCRIPTION

Phone cables used in most residential and business premises include two pairs of conductors, for a total of four wires. Each activated phone line uses one pair of conductors so that a single premises can utilize both pairs of conductors to operate two separate phone lines. The phone cable is routed from a premises interface box, where a phone service provider makes connections, and then throughout the premises to a series of wall-jacks. The wall-jacks that are most common utilize RJ11 modular sockets and RJ11 cables. The RJ11 cables are inserted into the sockets to connect POTS and data devices to the phone line. The RJ11 cables and sockets provide a way to connect to all four wires in the premises phone cable. At the socket outputs and the cable ends, the individual phone wires are arranged in a linear array and numbered 1, 2, 3 and 4, respectively. Generally, the first phone line signal is transmitted over wires 2-and-3, and if a second phone line is installed, the second phone line signal is transmitted over wires 1-and-4. Older phone wiring may not include RJ11 sockets, instead the four wires are accessible by removing a wall-plate or cover-plate, and then making connections directly to the individual wires.

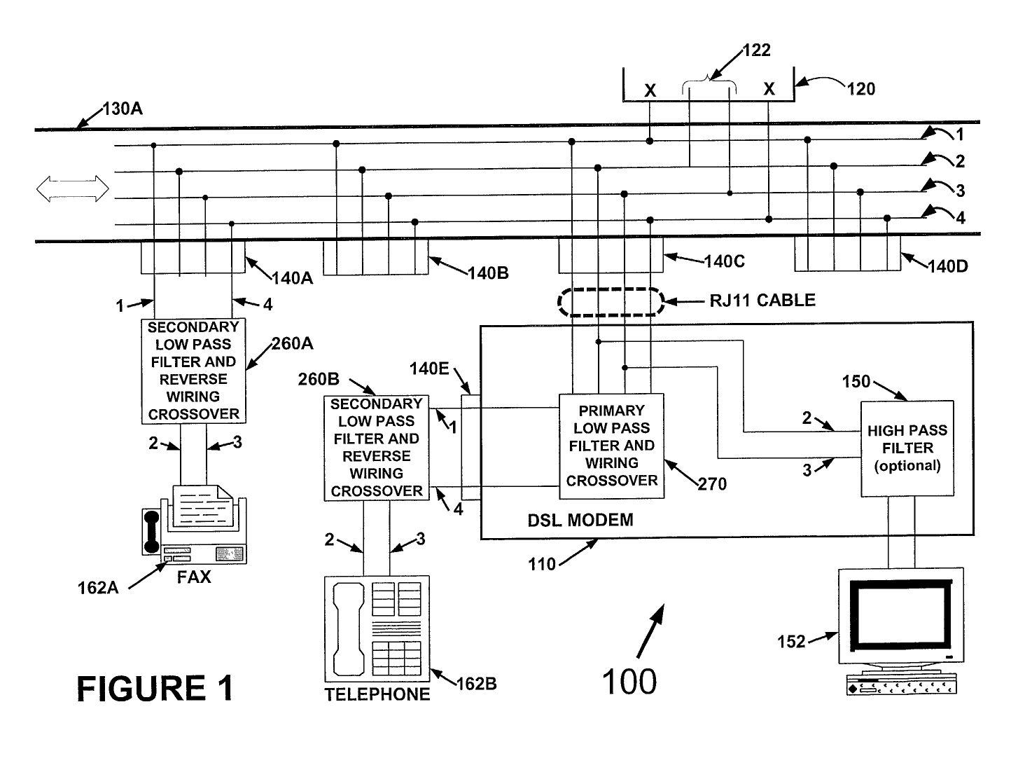

Referring to FIG. 1, splitterless DSL modem configuration 100 includes a DSL modem 110 connected to premises phone wires 1, 2, 3, and 4 which are routed through the premises within wall 130A. A combined DSL signal 122 is input by the phone service provider to the premises on phone wires 2-and-3 by connections at a premises interface box 120. In contrast, premises phone wires 1-and-4 are terminated at premises interface box 120, that is, phone wires 1-and-4 are not connected to an external phone signal. The premises phone wires 1, 2, 3 and 4 are routed through wall 130A and connected to several RJ11 wall sockets 140A-140D. DSL modem 110 is connected to the premises phone wires 1, 2, 3 and 4 by connecting an RJ11 cable into socket 140C and into DSL modem 110. Within DSL modem 110, the combined signal 122 from premises phone wires 2-and-3 is input to a high-pass filter 150, which outputs the HF data signals to desktop computer 152. Also within DSL modem 110, the premises phone wires 1, 2, 3 and 4 are connected to a primary low pass filter and wiring crossover 270. Primary low-pass filter and wiring crossover 270 includes a “wiring crossover” from wires 2-and-3 to wires 1-and-4, and also includes a low pass filter. In operation, the combined DSL signal 122 is input on wires 2-and-3, passed through the low-pass filter within 270, and the primary low-pass filtered (LPF) signals are output on wires 1-and-4. The primary LPF signal is output to RJ11 socket 140E and also output to the premises wires 1-and-4 through RJ11 wall-socket 140C.

POTS devices 162A and 162B receive the LF signals by connecting to secondary low-pass filters 260A and 260B, respectively, which are connected to wires 1-and-4 at RJ11 sockets 140A and 140E, respectively. The secondary low-pass filters 260A and 260B contain a “reverse wiring crossover” from wires 1-and-4 to wires 2-and-3. In operation, the primary LPF signals are received on wires 1-and-4 and passed through a secondary low pass filter within 260A and 260B, and a secondary LPF signal is output to POTS devices 162A and 162B, respectively, on wires 2-and-3.

By utilizing wires 1-and-4 of the premises wiring to transmit the primary LPF signals, and connecting all POTS devices through secondary low-pass filters, the POTS devices receive a “double-filtered” LF signal which reduces the negative effects on voice quality related to a combined DSL signal.

In another embodiment, “wiring crossover” and “reverse wiring crossover” connections described above are reversed, so that a combined DSL signal is transmitted on wires 1-and-4 and a low-pass filtered signal is transmitted on wires 2-and-3. In another embodiment, the primary low-pass filter and wiring crossover 270 is changed to a high-pass filter with wiring crossover to provide an HF signal that is transmitted over the premises wires 1-and-4.

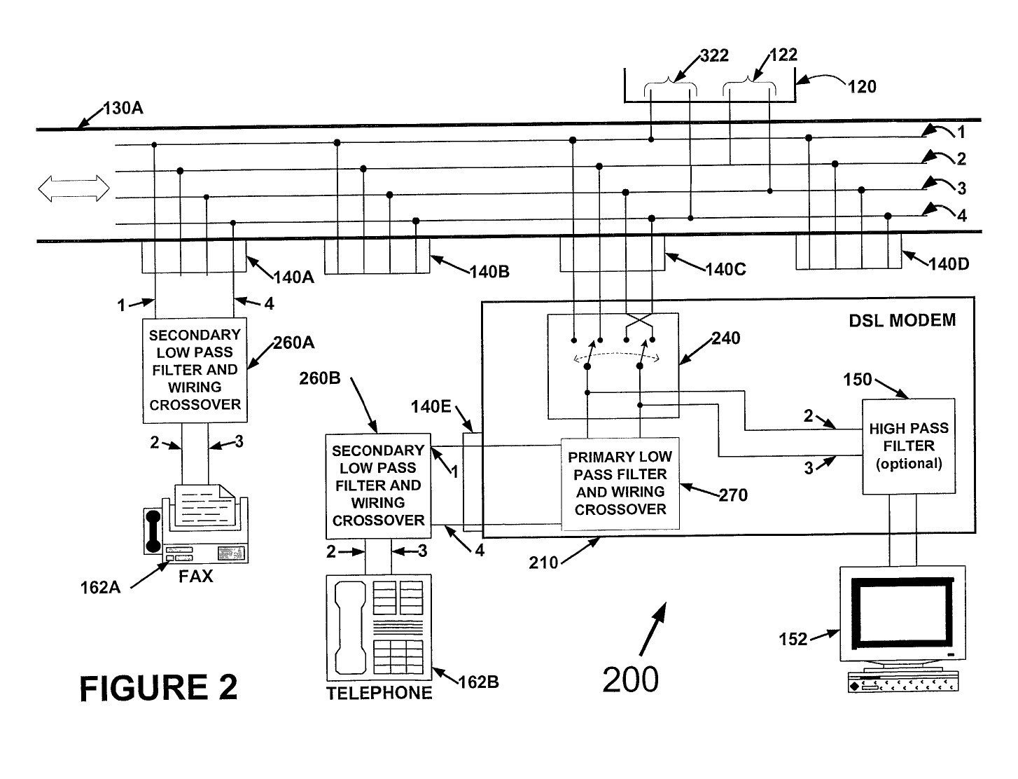

Referring to FIG. 2, a second splitterless DSL modem configuration 200 includes a double-pole-double-throw (DPDT) switch 240 contained within DSL modem 210. DPDT switch 240 switches between phone wire pairs 2-and-3 and 1-and-4, thereby selecting which phone line pair to use as the input to DSL modem 210. Two active phone connections 322 and 122 are provided at the interface box 120, and are connected to wire pairs 1-and-4 and 2-and-3, respectively. By switching DPDT switch 240 from one set of contacts to the other, a modem user can select a phone wire pair to for transmitting a combined DSL signal to DSL modem 210, while the other phone wire pair can transmit a second phone signal for use by other devices (POTS or data). Configuration 200 allows two phone lines to be installed and utilized, with one or both phone lines transmitting combined DSL signals or POTS signals only.

DPDT switch 240 is shown as part of DSL modem 210. Alternatively, DPDT switch could be provided in a separate apparatus, and connected between DSL modem 210 and the connection to the premises wiring.

Low-pass and high-pass filters may be constructed using passive or active components. Active filters have some performance advantages compared to passive filters, however, active filters require a power source to operate. In one embodiment, all of the filters in modem configuration 100 or 200 are provided as passive filters. In another embodiment, DSL modem 110 or 210 may include a power cord for connecting to AC power, which could provide a power source for implementing primary filter 270 and/or high-pass filter 150 as active filters. Furthermore, secondary low-pass filters 260A and 260B could be implemented as active filters, using either AC power or a DC power component from the phone line.

Primary low pass filter and wiring crossover 270 and high pass filter 150 are both shown as part of DSL modem 110 and 210. In alternative embodiments, high pass filter 150 is not included in DSL modem 110 or 210.

Some older POTS devices require a separate power source for powering optional equipment, e.g., Princess® phones may require a power source for back-lighting a dialing mechanism. This separate power source is often provided on wires 1-and-4 of the premises wiring. The embodiments of DSL modem configurations 100 and 200, use wires 1-and-4 for transmitting LF signals. Therefore, it is necessary to ensure that there are no power source connections to wires 1-and-4 before installing DSL modem 110 or 210.

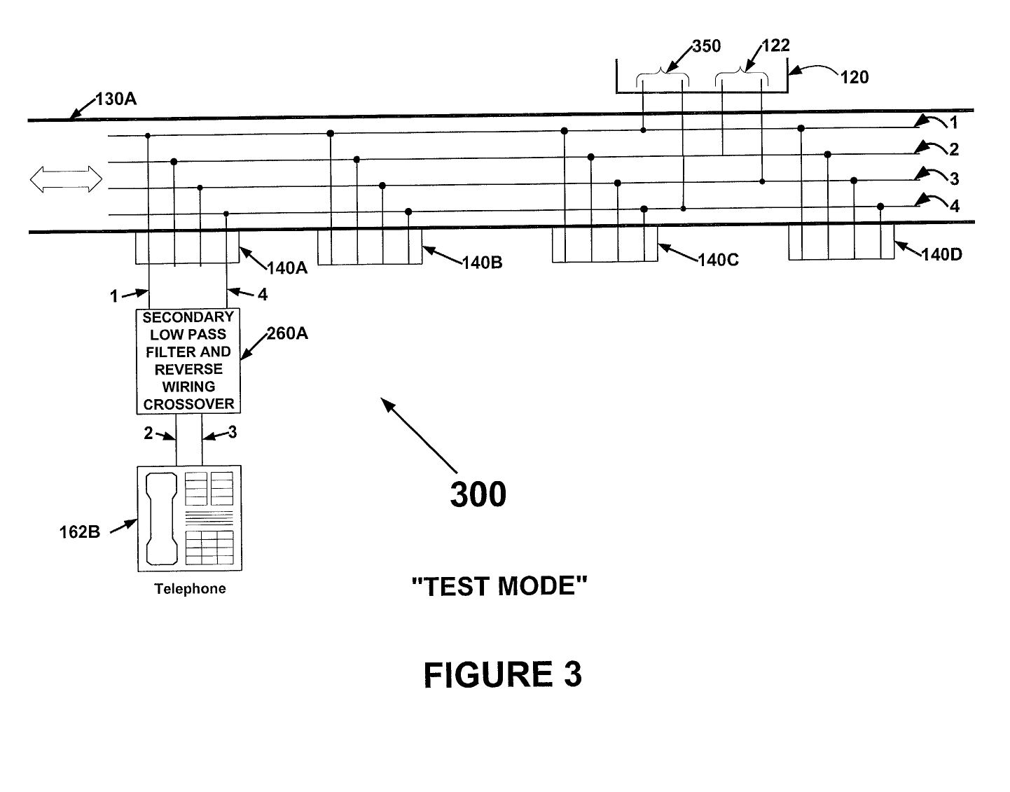

Referring to FIG. 3, secondary filter with reverse wiring crossover 260A is connected to phone wires 1-and-4 and to POTS device 162B, to provide a “test mode” configuration 300. Test mode configuration 300 allows a consumer to easily test line 1-and-4 for a power source (or signal) connection 350 at interface box 120, before attempting to utilize these lines for transmitting other signals (e.g., as shown above in configuration 100 or 200). POTS devices 162B is connected to wires 2-and-3 through secondary filter and wiring crossover 260A. If the consumer hears silence on the POTS receiver, then wires 1-and-4 are not connected to a power source, however, if the consumer hears any noise on the line, then a service call must be made to the phone service provider to disconnect wires 1-and-4 from their power source. The test mode configuration 300 allows a user to avoid making a service call to have wires 1-and-4 tested for a power source connection.

As discussed above, the wiring crossover and reverse wiring crossover connections swap the input of phone wire pair 2-and-3 to output on phone wire pair 1-and-4. The pairing of 2-and-3 and 1-and-4 could be altered so that any phone wire pair combination could be used for transmitting signals.

A number of embodiments of the invention have been described. Nevertheless, it will be understood that various modifications may be made without departing from the spirit and scope of the invention. Accordingly, other embodiments are within the scope of the following claims.

What is claimed is:

1. An apparatus comprises:
an input/output port for receiving and transmitting a combined signal on a first set of wires and transmitting a primary filtered signal on a second set of wires; and
a first filter having
an input port for receiving the combined signal from the first set of wires,
a primary filter for receiving the combined signal and outputting a primary filtered signal, and
an output port for transmitting the primary filtered signal on the second set of wires.

2. The apparatus of claim 1 wherein the first set of wires and the second set of wires comprise phone wires.

3. The apparatus of claim 2 wherein the combined signal comprises a DSL signal.

4. The apparatus of claim 2 wherein the primary filter comprises a low-pass filter.

5. The apparatus of claim 4 wherein the combined signal comprises a DSL signal.

6. The apparatus of claim 5 wherein the low-pass filter comprises an active filter.

7. The apparatus of claim 5 wherein the low-pass filter comprises a passive filter.

8. The apparatus of claim 1 further comprising:
a second filter having
an input/output port for receiving and transmitting the primary filtered signal on the second set of wires,
a secondary filter for receiving the primary filtered signal and outputting a secondary filtered signal, and
an output port for transmitting the secondary filtered signal on a third set of wires to a POTS device.

9. The apparatus of claim 8 wherein the first set of wires and the second set of wires are phone wires.

10. The apparatus of claim 9 wherein the combined signal comprises a DSL signal.

11. The apparatus of claim 8 wherein the secondary filter comprises a low-pass filter.

12. The apparatus of claim 11 wherein the combined signal comprises a DSL signal.

13. The apparatus of claim 13 wherein the low-pass filter comprises an active filter.

14. The apparatus of claim 13 wherein the low-pass filter comprises an passive filter.

15. The apparatus of claim 2 further comprising:
a switch circuit coupled to the input/output port and the input port of the first filter, the switch circuit configured to control the selective coupling of the first set of wires or the second set of wires to the input port of the first filter.

16. A phone line testing apparatus comprises:
an input port for receiving a signal from wires 1-and-4 of a RJ11 phone jack;
a primary filter for receiving the signal from the wires 1-and-4 and outputting a filtered signal; and
an output port for transmitting the filtered signal on wires 2-and-3 of a RJ11 phone jack to a receiving device.

17. The apparatus of claim 16 wherein the receiving device comprises a POTS device.

18. A method for testing a phone line comprising:
inputting a signal from wires 1-and-4 of a RJ11 phone jack;
filtering the signal;
outputting a filtered signal on wires 2-and-3 of a RJ11 phone jack;
receiving the filtered signal at a receiving device; and
listening to the received filtered signal at the receiving device.

19. The method of claim 18 wherein the receiving device comprises a POTS device.

20. A method for receiving and transmitting a combined signal over phone wires comprises:
receiving a combined signal on a first set of phone wires;
filtering the combined signal; and
outputting a primary filtered signal on a second set of phone wires.

21. The method of claim 20 wherein receiving a combined signal comprises receiving a DSL signal.

22. The method of claim 20 wherein filtering the combined signal comprises filtering with a low-pass filter.

23. The method of claim 22 wherein receiving a combined signal comprises receiving a DSL signal.

24. The method of claim 23 wherein the low-pass filter comprises an active filter.

25. The method of claim 23 wherein the low-pass filter comprises a passive filter.

26. The method of claim 20 further comprising:
receiving the primary filtered signal on the second set of phone wires;
filtering the primary filtered signal; and
outputting a secondary filtered signal on a third set of phone wires to a POTS device.

27. The method of claim 26 wherein receiving a combined signal comprises receiving a DSL signal.

28. The method of claim 26 wherein filtering the primary filtered signal comprises filtering with a low-pass filter.

29. The method of claim 28 wherein receiving the combined signal comprises receiving a DSL signal.

30. The method of claim 29 wherein the low-pass filter comprises an active filter.

31. The method of claim 29 wherein the low-pass filter comprises a passive filter.

32. The method of claim 26 further comprising:
switching between the first set of phone wires and the second set of phone wires to select which set of wires are connected to an input port of a first filter.
